(19) United States
(12) Patent Application Publication
(10) Pub. No.: US 2017/0148032 A1
(43) Pub. Date: May 25, 2017

(54) COLLECTABLE ITEM CONDITION CERTIFICATION SYSTEM

(71) Applicants: Scott C. CORNIUK, Mentor, OH (US); Joan E. CORNIUK, Mentor, OH (US)

(72) Inventors: Scott C. CORNIUK, Mentor, OH (US); Joan E. CORNIUK, Mentor, OH (US)

(21) Appl. No.: 15/361,361

(22) Filed: Nov. 25, 2016

Related U.S. Application Data
(60) Provisional application No. 62/259,646, filed on Nov. 25, 2015.

(51) Int. Cl. G06Q 30/00; G06K 3/00; G06K 19/06; H04L 29/06

(52) U.S. Cl. CPC G06Q 30/018; H04L 63/10; G06K 3/00; G06K 19/06065

(57) ABSTRACT

A method of certifying the condition of a collectible item, including establishing a unique identification number for the item; evaluating the item and determining a numeric grade for the overall condition of the item; entering the item identification number and the numeric grade in a worksheet; saving a read-only record copy of the worksheet in a registration database keyed to the identification number; generating no more than two identical labels with the identification number for the item; creating a separate registration certificate that displays the numeric grade for the overall condition and other identifying information for the item; applying one of the identical labels to the registration certificate; and applying the other one of the identical labels to the item or a container of it. The labels are secure ID Tags, being unalterable and tamper evident by destruction if removed. They form a security seal when affixed to a container.

### CROSS-REFERENCE TO RELATED APPLICATIONS

This application claims the benefit of U.S. Provisional Patent Application No. 62/259,646 filed on Nov. 25, 2015 which is incorporated in its entirety herein by reference.

### TECHNICAL FIELD OF THE INVENTION

The present invention relates to a collectable item certification system that aids in the management of collectable items. More specifically, the present invention relates to a collectable item certification system that implements the standardized grading criteria in a way that makes grading less subjective.

### BACKGROUND OF THE INVENTION

There are a huge number of items that can be described as collectibles. They include art, books, and periodicals, cards, ephemera, clothing, fabric, textiles, coins, currency, stamps, glass, pottery, household items, kitchen collectibles, records, musical instruments, things relating to nature and animals and novelty items to name a few. At present, only a few of these have a recognized way to grade the quality (condition) in a way that is useful for determining monetary value—notably comic books, trading cards, and coins.

For any of these items, there needs to be a verifiable means of grading and pricing the items so that they can be sold.

It is important to note that there are differences between grading and appraisal (price/value determination): That is, price depends upon market factors (e.g., demand, and/or rarity=supply) and other subjective criteria as well as the condition (grade) of the item. Price for a rare, sought after, item will be high, even if in “fair” condition, but a present day issue of a superman comic, for example, may not be worth the cover price even if in “mint” condition. On the other hand, Grade for an item is ideally objectively determined (best if by a trusted authority), and then used as a basis for establishing price after accounting for supply and demand factors. An established grade may be used at a later time, but only if confidence can be established the actual condition has not changed since it was graded.

An example of comic books is useful to further appreciate the various factors in grading and appraisal (price/value determination).

For comic books, the term grade is used to describe what condition a comic book is in. You can think of the grade of a comic book like a grade on a report card. A high grade, like an A or Mint, is good, while a low grade, like and F or Poor, is bad. Is the cover bent or torn? Is there writing on it, are there tears or discoloration? All of these things and more need to be taken into consideration when one is trying to grade a comic.

At the moment, there are two different types of grading that you will find. You can grade the comic book yourself, or you can have another party grade it for you.

There are third party grading companies such as, CGC (Comics Guaranty Company), that that will grade your comic book for you, for a price. You can simply ship the comic book to them or take it to a convention where they will be. They will tell you what grade it is considered to be. Then, they will put in a protective sleeve and seal it.

There has been a recent rise in the value of CGC graded comic books. Buyers now have a very good idea as to what the condition of a comic book is. Again, Grading comics can be very subjective and having a company like CGC give their opinion can make comic books go for much more than their cover price, especially those with high grades.

This might lead one to think that every comic book be graded by a company like CGC. But it's important to remember that the company charges a cost for every comic book graded, and not every comic book is going to be worth it, not even after it is graded. There is also the extra cost of getting comics graded. One comic book out of a collection isn't a big deal, but if the collector has thousands of comics, the cost in justifying getting every single comic book graded by a company like CGC doesn't make sense.

This prior art practice of the 3rd party graders providing a client with a grade on the comic book, and maybe also appraise its dollar value does have some shortcomings. Because the grader is not actually buying the item, the “grade” has limited worth when the client wants to sell the item later. Problems with prior art grading include: the grade is according to their criteria, which may not be recognized by others; there isn't any way to confirm that the item being sold is the same item that was graded; the grade may be lost; a certificate or other report of the grade could be forged or otherwise falsified or modified; and the graded item (e.g., comic) may deteriorate over time, or be damaged by handling etc., since the date that the grade was established.

Of course, a collector can always grade their own comic books. After careful inspection, the collector can decide from the following list of grading terms what best represents its condition: Mint, Near Mint, Very Fine, Fine, Very Good, Good, Fair, or Poor.

Still, grading a comic book is a very subjective thing. That means what is Mint to one person might not be Mint to another. When buying a graded comic, one must be sure that it meets their understanding of the grading term. When selling a comic, one must be sure to seriously evaluate the condition and state what it should be. If the seller fails to properly grade the comic book, they can face some heavy backlashes in the form of negative feedback from online auction users, broken trust, and maybe even having civil action taken against them.

In any event, when the grade of a comic is properly determined, both the buyer and the seller are protected. Properly graded comic books will help future auctions as a seller and will help the buyer make the best decision about a purchase. It will also lead to comic collection rise in value.

Another problem with current grading systems is that it is difficult to determine the actual condition of an item from a grade such as “Mint”, “Good”, etc. In some cases, a numeric value is associated with gradations but this still leaves a lot of latitude in meaning.

Coin grading is an example. A “grade” measures a coin's appearance. There are generally five main characteristics which determine a coin's grade: strike, surface preservation, luster, coloration and eye appeal. Grading is subjective and even experts can disagree about the grade of a given coin.

Several grading systems have been developed. U.S. coin grading has evolved over the years to a system of finer and finer grade distinctions. Originally, there were only two grades, new and used. This changed to the letter grading system beginning with the lowest grade—Basal State (also Poor (PO)), then continuing Fair (Fr), About or Almost Good (AG), Good (G), Very Good (VG), Fine (F), Very Fine (VF), Extremely Fine (EF), Almost or About Uncirculated (AU), Uncirculated (Unc) and up to Brilliant Uncirculated (BU). As the collector market for coins grew rapidly in the late 19th and early 20th centuries, it became apparent that a more precise grading standard was needed. Some coins were simply more fine than others, and some uncirculated coins showed more luster and far fewer marks than others. Terms like “gem uncirculated” and “very fine” began to see use, as more precise grading descriptions allowed for more precise pricing for the booming collector market. In 1948, well-known numismatist Dr. William Herbert Sheldon attempted to standardize coin grading by proposing what is now known as the Sheldon Scale which is a 1 to 70 point grading scale with 1 being “poor”. Certification services now professionally grade coins for tiered fees.

Regardless of the scale being used, individual grade names or associated point values, are determined by comparing the coin to a list of grade descriptions wherein each grade has a paragraph detailing a range of allowable conditions for each of the characteristics. This is manageable with training, mainly because there are only 5 characteristics to consider for each grade.

Another important example is comic book grading which is in high demand, but is greatly complicated because there are many more than 5 characteristics to be considered. The best known and trusted grading system was established by Overstreet and used to publish first THE OVERSTREET COMIC BOOK PRICE GUIDE followed later by THE OVERSTREET COMIC BOOK GRADING GUIDE.

The Grading Guide defines criteria for a 10 point grading scale for condition of comic books, including, for example, an OWL card that illustrates different levels of “whiteness” for the comic book paper. (OWL=Overstreet Whiteness Level). Numeric grades have corresponding labels, with many subdivisions sequentially separated by 0.1 to 0.5 differences. For each overall grade, a verbal description is given of the allowable range of conditions for each of a variety of characteristics. This is problematic because the grader must determine the right mix of many simultaneous variable values. Example of numeric grades with labels follows, (sequential numbers separated by comma, and ellipsis ( . . . ) indicates skipped numbers):
10.0 GEM MINT, 9.9 MINT . . .
9.0 VERY FINE/NEAR MINT, 8.5 VERY FINE+, 8.0 VERY FINE . . .
6.0 FINE . . .
4.0 VERY GOOD . . .
2.0 GOOD . . .
1.0 FAIR, 0.5 POOR=lowest grade

To see how long and involved a description can be for a single grade, and how subjective the evaluation can be, consider the following descriptions/definitions of the top two Overstreet Comic Book Grades as reported on CollectiblesShop.com website (Comments added by Collectibles Shop are indicated by italic font in parentheses). The definitions are copyright 2014 Gemstone Publishing, Inc., and OVERSTREET® is a Registered Trademark of Gemstone Publishing, Inc.:
“10.0=GEM MINT (GM): An exceptional example of a given book—the best ever seen. Only the slightest bindery or printing defects are allowed. (Not with most grading services though, perfect means perfect.) Cover is flat with no surface wear. Inks are bright with high reflectivity. Corners are cut square and sharp. Spine is tight and flat. Staples must be original, centered and clean with no rust. Paper is white supple and fresh. No interior autographs or owner signatures. (Many modern comics—1990s-up, and some earlier special issues—are printed edge-to-edge with color or images, so they aren't on white pages to begin with, and there's no white borders. So fading is about the only way to tell degradation. But they will still get a ‘white pages’ notation on the pro-graded labels)”
“9.9 MINT (MT): Near perfect in every way. Only subtle bindery or printing defects are allowed. (“Subtle” as in nearly invisible, and grading companies may not allow it for their 9.9 either.) Cover is flat with no surface wear. Inks are bright with high reflectivity and minimal fading. Corners are cut square and sharp. Small, inconspicuous, lightly penciled, stamped or inked arrival dates are acceptable as long as they are in an unobtrusive location. Spine is tight and flat. Staples must be original, generally centered and clean with no rust. Paper is white, supple and fresh. (Back cover stamps/writing is less ‘offensive’ to most collectors, but most collectors don't like them on the front, so comics with front cover stamps/writing usually fetch lower prices for the same grade, and many dealers will downgrade a bit for such stamps/writing. To me, this applies to most grades of 9.2 or above, others may consider a wider or smaller range.)”

It is an object of the present invention to overcome the many problems and deficiencies evident in the prior art for collectable item condition description (e.g., by grading), and for certification of condition.

### SUMMARY OF THE INVENTION

According to an embodiment of the present invention, there is disclosed a method of certifying the condition of a collectible item. The method includes establishing a unique identification number for the item; evaluating the item and determining a numeric grade for the overall condition of the item; entering the item identification number and the numeric grade in a record copy; saving the record copy in a registration database keyed to the identification number; generating two identical labels with the identification number for the item; creating a separate registration certificate that displays the numeric grade for the overall condition and other identifying information for the item; applying one of the identical labels to the registration certificate; and applying the other one of the identical labels to the item.

According to another embodiment of the present invention, there is disclosed a method of certifying the condition of a collectible item. The method includes establishing a unique Identification number for the item; evaluating the item and utilizing the system member's computer, which incorporate software; entering the details of the item into the software; generating a score of the item; entering the score of the item into a server; and generating a label with a unique ID code for the item.

According to another embodiment of the present invention, published standardized grading criteria are implemented in a computerized way that makes grading less subjective and therefore more uniform and repeatable among all persons doing the grading.

Also according to the present invention, a unique and secure (non-alterable) identification (ID) tag is applied both to the item and to a separate certificate of grade. These two tags are the only existing copies.

Further according to the present invention, the certificate of grade can be stored separately from the item to prevent simultaneous loss (e.g., in a safety deposit box).

Also according to the present invention, the unique ID tag number plus the associated grade is saved in a secure database, preferably that is publicly searchable.

Still further according to the present invention, an independent database provides means for confirming the certificate information and the ID tag is physically unalterable and can't be duplicated.

Yet further according to the present invention, the certificate is dated, and the item is placed in a protective/tamper-proof enclosure. The ID tag is applied to the enclosure such that it will be destroyed if the enclosure is opened.

A further according to the present invention, the owner of the item can be registered in the database along with the ID, and optionally provided on the certificate, thereby providing evidence of theft.

Still further according to the present invention, a title of ownership is created and can be transferred.

Also according to the present invention, a grading registration card/title is created that can be used for providing proof of ownership and condition to insurance companies and police departments in case of loss.

### BRIEF DESCRIPTION OF THE DRAWINGS

The structure, operation, and advantages of the present invention will become further apparent upon consideration of the following description taken in conjunction with the accompanying figures (figures.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front view of a template for a certificate of a graded trading card prior to printing designated info and affixing a secure ID Tag, in accordance with the present invention.

FIG. 1A is a front view of a Registration Certificate of a Collectable Item, with registered information including a non-system grade printed and secure ID tag affixed, in accordance with the present invention.

FIG. 2 is a back view of the certificates shown in FIGS. 1-1A, in accordance with the present invention.

FIG. 3 is a top view of an item secured in a container with closure securely sealed by one of a pair of ID Tags, in accordance with the present invention.

FIG. 4 is a chart showing data in an item owner account information portion of a collectable item registration database, in accordance with the present invention.

FIG. 5 is a chart showing item information data in a trading card portion of a collectable item registration database, in accordance with the present invention.

FIG. 6 is a trading card version of a grading worksheet showing data entry fields for identifying information and evaluated conditions of item characteristics, in accordance with the present invention.

FIG. 7 is two partial views of the grading worksheet showing examples of dropdown box condition selections with resulting grade point deductions, in accordance with the present invention.

FIG. 8 is a chart showing a matrix of combined characteristic conditions with resultant overall grading score, used by the system to determine independent point deductions for each of the conditions, in accordance with the present invention.

FIG. 9 is a card showing card showing a grading evaluation tool, in accordance with the present invention.

FIG. 10 is a schematic view of a collectible item certification system, in accordance with the present invention.

FIG. 11 is a flow chart of the method of utilizing the collectible item certification system, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, names) will be used to identify elements. If legends are provided, they are intended as an aid to the reader, and should be interpreted in light of the specification description which is controlling. Similarly, other annotations on the drawing sheets are to be considered as a part of the description, but secondary to the specification which is controlling if different. Textual content in the illustrated elements (e.g., a certificate, a worksheet, and the like) is shown as an example of text that may be part of an embodiment of the invention or element of the invention.

For convenience, aspects of the present invention may be labeled as “SNM” aspects, where SNM is an acronym for the organization name of the present system embodiment: “Sports'N′More”, which may be trademarked, but should not be considered a permanent or fixed name, only as a convenient reference to the herein disclosed invention, its owner or overall business entity/organization. The SNM label may be used inconsistently in the description, and is not required as an indication of invention aspects, and the organization aspect of the invention may be simply referenced as “the system” (optionally capitalized as “the System”).

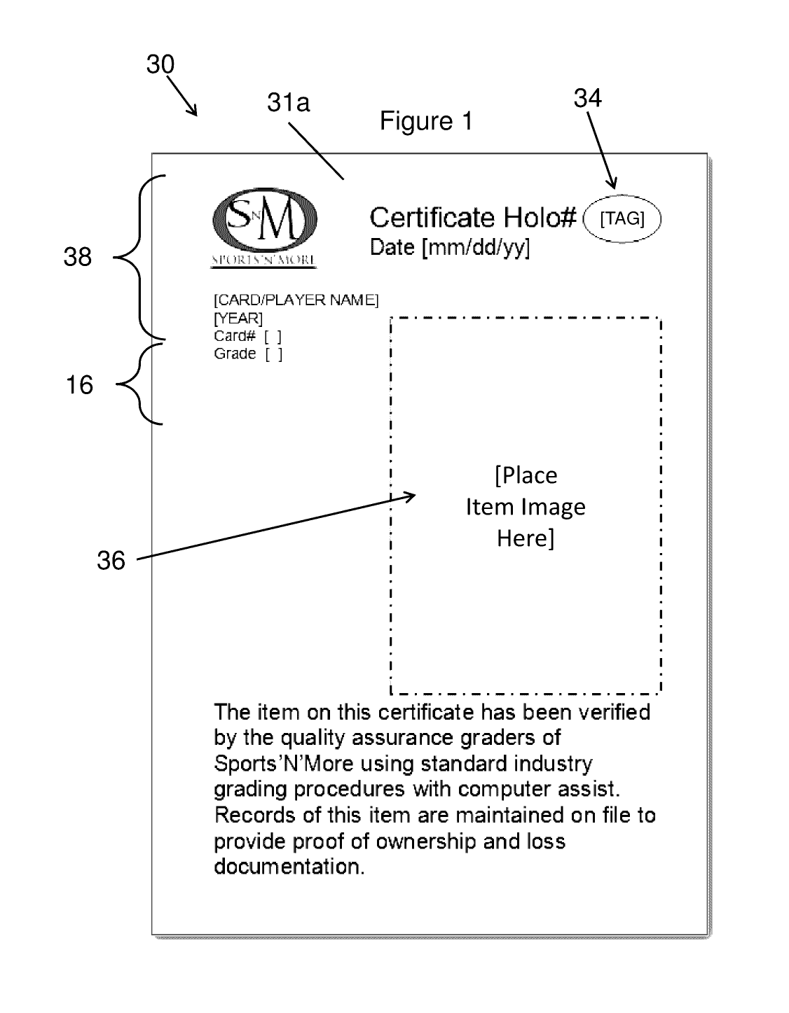

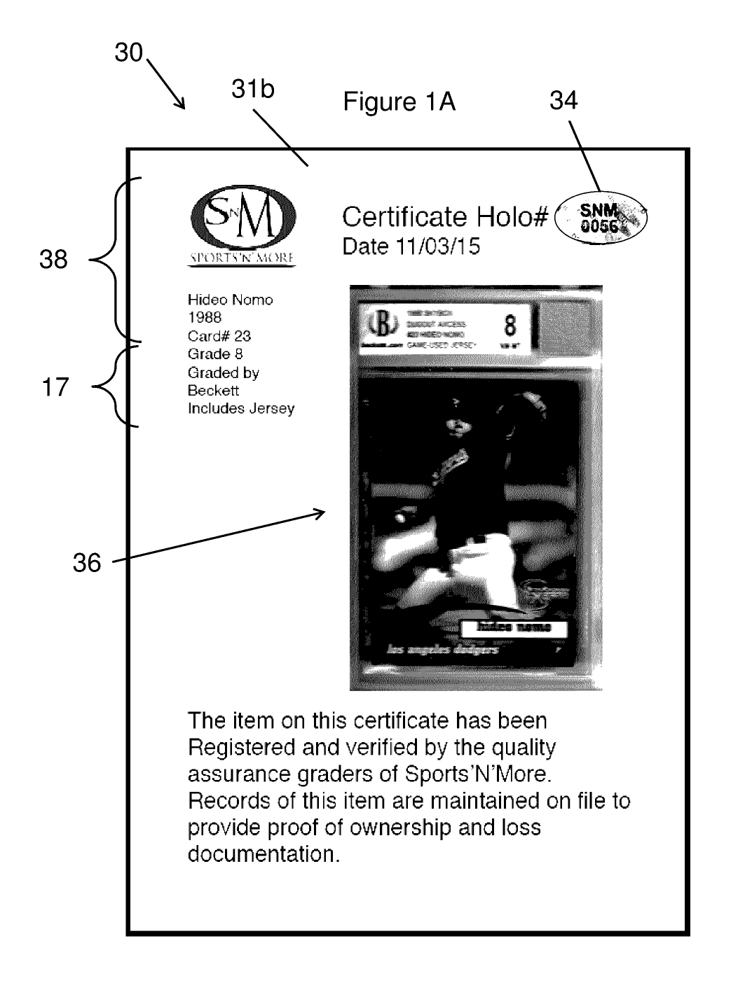

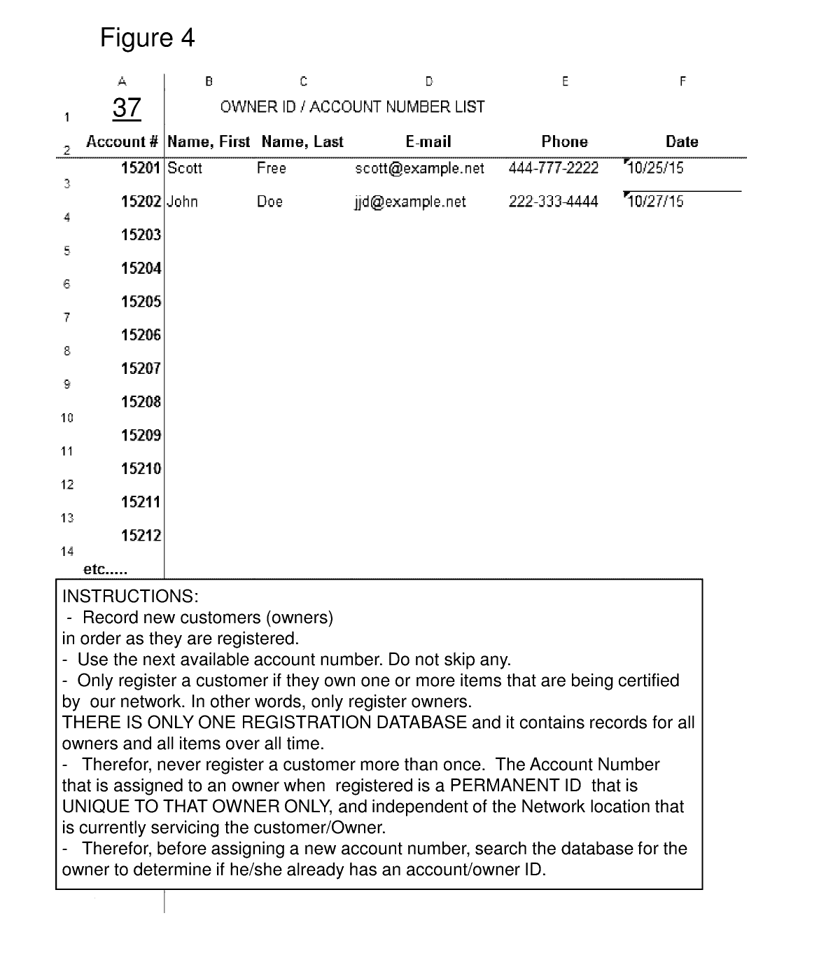

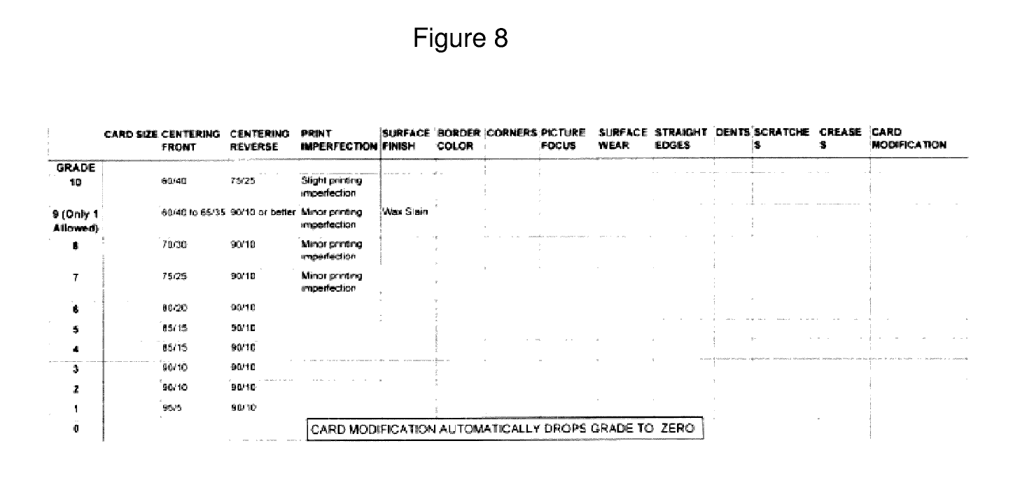

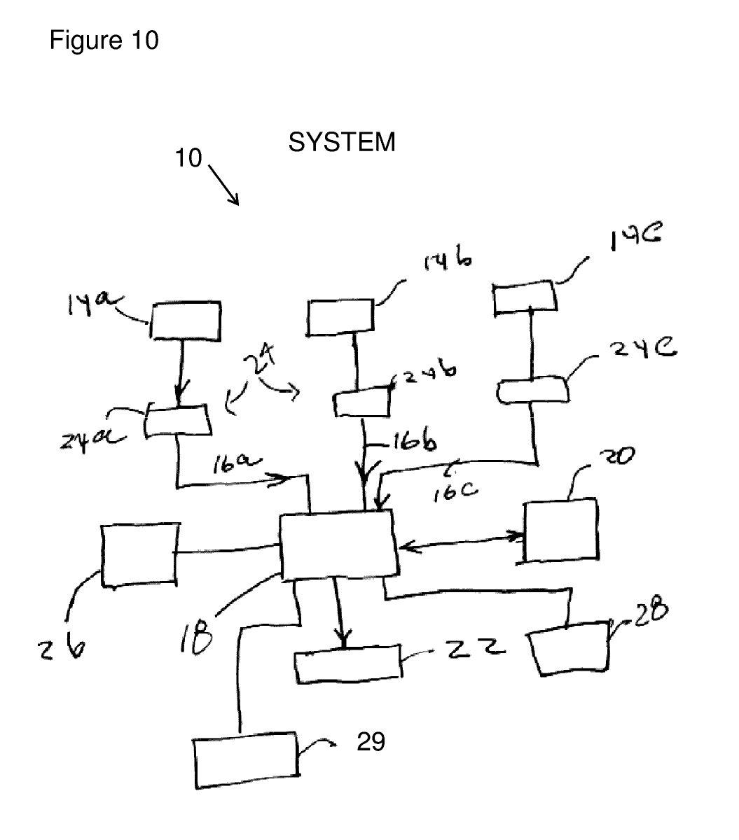

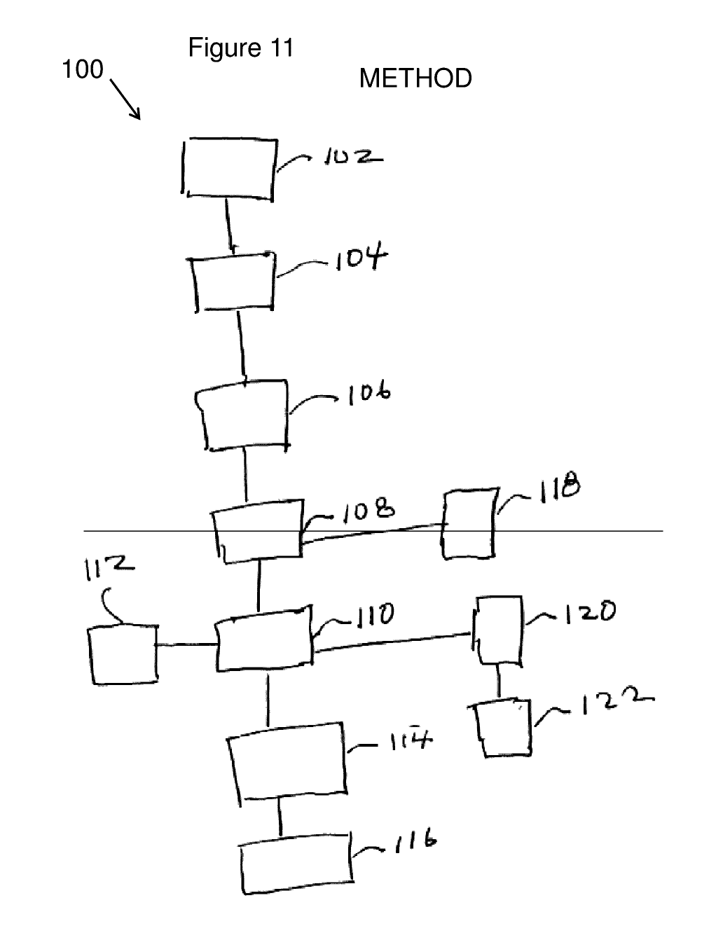

The presently disclosed “Collectable Item Condition Certification System” (or item Certification System) concerns a System (e.g., the SNM System 10, see FIG. 10) that employs a particular method (see FIG. 11) that addresses prior art deficiencies in the management of collectable items (“items”), particularly with respect to: secure identification and certification of a particular item and its ownership see (FIGS. 1-3); standardized criteria, and method for consistent/repeatable application of the standardized criteria, for evaluation (grading) of the overall condition/quality of a particular item (to enable good value determination by others, even after item is lost) see FIGS. 4-9; and documentation of item ownership and condition grade, stored in a secure, externally accessible database maintained by the System, see FIG. 10.

Thus the documented data about each item is available independent from the item owner so that purchasers, insurers, and the like can independently determine item value—for insurance purposes without needing to see the actual item (e.g., if an insured item is lost); or for a preliminary estimate for use by a potential purchaser wanting to determine worthiness of personally inspecting the item or otherwise further investing time or money in purchase of it; Trustworthy documentation (database data cannot be altered), and bias-free condition/quality evaluation (grading)—i.e., independent of arbitrary criteria used by individual appraisers.

The inventive SNM system 10 includes some or all of the following features and aspects: a) a Network 14 of approved graders (SNM Network Members 14a, 14b, 14c (14a-14c)), which yields a universally understood and trusted SNM grade 16 (a standardized “score” 16a, 16b, 16c (16a-16c) and predefined terms used to describe item condition and identification) to a server 18.

Each type/kind of item can have its own set of examination specifications and guidelines for grading (grading criteria). SNM will establish a grading specification for each kind of item that will be graded within the SNM Network Of Approved Graders. The grading specification will be enforced as a single standard that is universal and uniformly applied throughout the SNM Network, thereby establishing an SNM branded grade. Uniform implementation of a Grading specification is enforced by the Grader's required usage of software that has the SNM system method (of grading and identifying items) and item specific specification of criteria embodied in it. The software provides a procedural template that reminds and enforces orderly implementation of the SNM Method steps for evaluating an item to establish a standardized condition grade. For example, the evaluation process software and/or template may be a worksheet (e.g., a spreadsheet) wherein data is entered as the method is followed.

Typically, software provides a point deduction system wherein the procedural template includes one or more charts or spreadsheets that list grade point deduction amounts for every condition of each item characteristic. This is a flexible approach that enables consistent grading regardless of the evaluator—because the defects in the item being evaluated are considered separately rather than all at once. This also enables application of his system to grading of any (collectible) item type. Generally, a specific worksheet is created for each type of item being evaluated. Each worksheet includes the important characteristics and a list of possible conditions for each characteristic of the item being evaluated and the corresponding point deductions for each characteristic.

The software enforced grading is important for consistency. Each grading spreadsheet is a template, being constantly with the most recent rules as to evaluating an item. A new copy of the spreadsheet is used for the process of grading each specific item. When the grading is done, a read-only record copy is saved in the database with the other information relating to the item ID because it now documents all of the grading selections that were made for the specific item. That information will help in the future when someone wants to know what the numeric grade means.

The evaluator evaluates each condition characteristic provided in a predetermined list on the spreadsheet, typically incorporated in the software. The evaluator then selects a condition descriptor from the list of descriptors provided in the spreadsheet for the characteristic, and enters the corresponding grade point deduction that is shown with the selected descriptor. The software calculates the items final grade being a perfect score number (e.g., 10) minus a sum of the grade point deductions. Preferably the point deduction entry is automated according to selection of a condition.

An aspect of the present invention is that if a characteristic is not graded, the deduction value will be blank on the spreadsheet and the software will not calculate a final grade. This aspect of the software enforces evaluation of all characteristics

The following is required for membership in the SNM Network:
a. Each network member 14a, 14b, 14c uses a single standardized set of examination specifications and guidelines for grading (SNM Grading specifications) that has been predetermined for each kind of item to be graded.
b. Each network member 14a, 14b, 14c uses a predetermined standardized method for evaluating and/or grading the condition of the item.
c. Each member 14a, 14b, 14c uses the SNM Grading specifications (including standardized terms) which is assured by the required use of the SNM system software that has the method of grading and identifying an item embedded therein.
d. Membership in the SNM Network may be obtained, for example, by purchase of a franchise, or according to any other business model at the discretion of the SNM System owner and/or controllers.

A secure, independent Registration Database 20 with controlled read-only access by qualified interested parties receives the standardized “scores” 16a-16c as graded by the Network Members 14a-14c from the server 18.

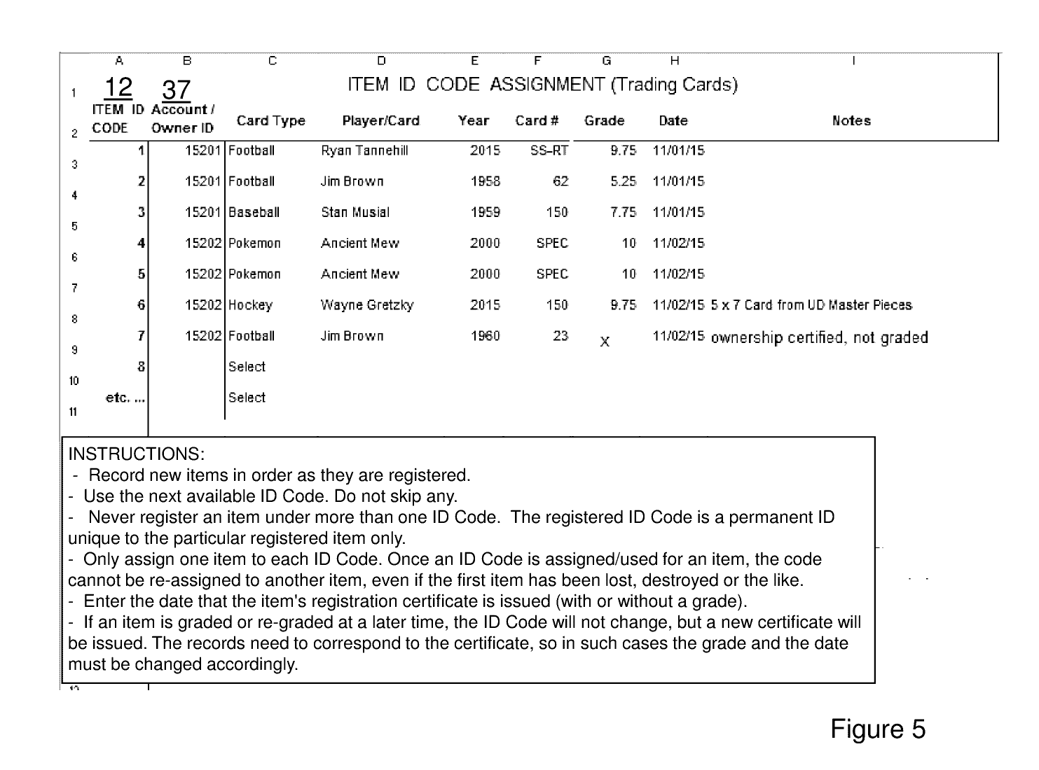

The Registration Database 20:
a. Contains records of data from every issued SNM registration certificate, keyed by owner account number and item ID code (See FIGS. 4-5);
b. Maintained by SNM system 10, which controls the database contents and data and is thus independent of the item's owners or others with special interests. The Data within the Registration Database 20 is secure because it contains read-only data that cannot be altered by anyone other than through the (internal) SNM system 10, such as by a network member 14a, 14b, 14c.
c. Data within the Registration Database 20 may be made available through the server 18 to a secure internet website 22 (e.g., that is cloud based, encrypted, controlled access such as by password, and optionally limited to those with specific permissions).
d. The data within the Registration Database 20 is accessible via controlled external read-only access, such as a computer 29 connected to the server 18. Access to the Registration Database 20 may be limited to a specific owner and/or item records, and may require that the accessing entities be qualified by criteria such as: owner permission (e.g., owner grants to prospective item buyer); or a documented “need to know” (e.g., by insurance providers, law enforcement, etc.)

The SNM system 10 (FIG. 10) incorporates a plurality of computers 24, each of which includes software 24a, 24b, and 24c (24a-24c) that has the SNM method of grading and identifying items, as detailed in FIG. 11, embodied in it. The software 24a-24c provides a procedural template (Worksheet 50) that reminds and enforces repeatable and consistent implementation of the SNM method for evaluating an item to establish a standardized condition grade 16. The Network members 14a-14c utilize the software 24a-24c to establish the standardized “scores” 16a-16c which are output from the computers 24. To establish the standardized “scores” 16a-16c, grading rules (predetermined evaluation steps) in the data entry/evaluation worksheet 50 are selected for each item-specific characteristic 52 wherein each characteristic 52 has an associated list of condition descriptors 54, each of which has a corresponding grade point deductions. For evaluating each condition characteristic in a predetermined list contained in the worksheet 50, the evaluator/grader 14 (e.g., network member 14a-14c), selects a corresponding condition descriptor 54 from the list of descriptors provided for the characteristic 52, and enters the corresponding grade point deduction 56 that is shown with the selected descriptor; and the software 24 controlling the worksheet 50 calculates the item grade (overall condition/grade/score) being a perfect score number minus a sum of the grade point deductions 56. In a preferred embodiment, the perfect score is 10.00 and the point deductions are numbers with two decimal places, thereby allowing score values to vary by as little as 0.01 points, whereas typical prior art grades use a perfect score of 10.0 and allow increments of 0.1 or more.

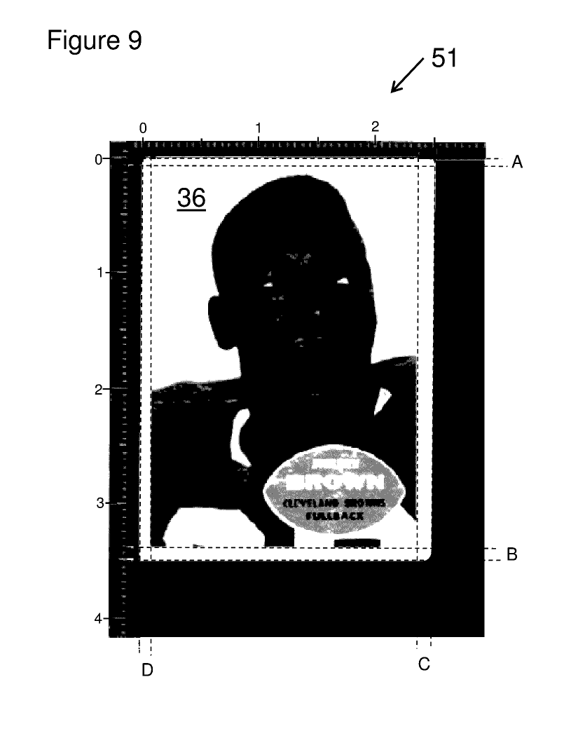

The software 24a-24c may provide one or more evaluation “tools” 51 to enhance the evaluator's ability, accuracy, and consistency. In a typical example illustrated by FIG. 9, an image of the item, that may be magnified, is simultaneously displayed on a monitor/display screen of the computer 24 along with a measurement scale and cursors that can be aligned with elements of the image to provide accurate measurements of elements such as borders around an image on a trading card. In another example, not illustrated, an image of the item, that may be magnified, is simultaneously displayed on a monitor/display screen of the computer 24 along with a chart of condition example images (e.g., colors with standardized names, e.g., an OWL chart/card) to aid in determining a characteristic condition 54 to select in the predetermined list. Or, for example, the item image may be displayed with image enhancement tools (e.g., magnification) to enable finding and evaluating the severity of defect conditions.

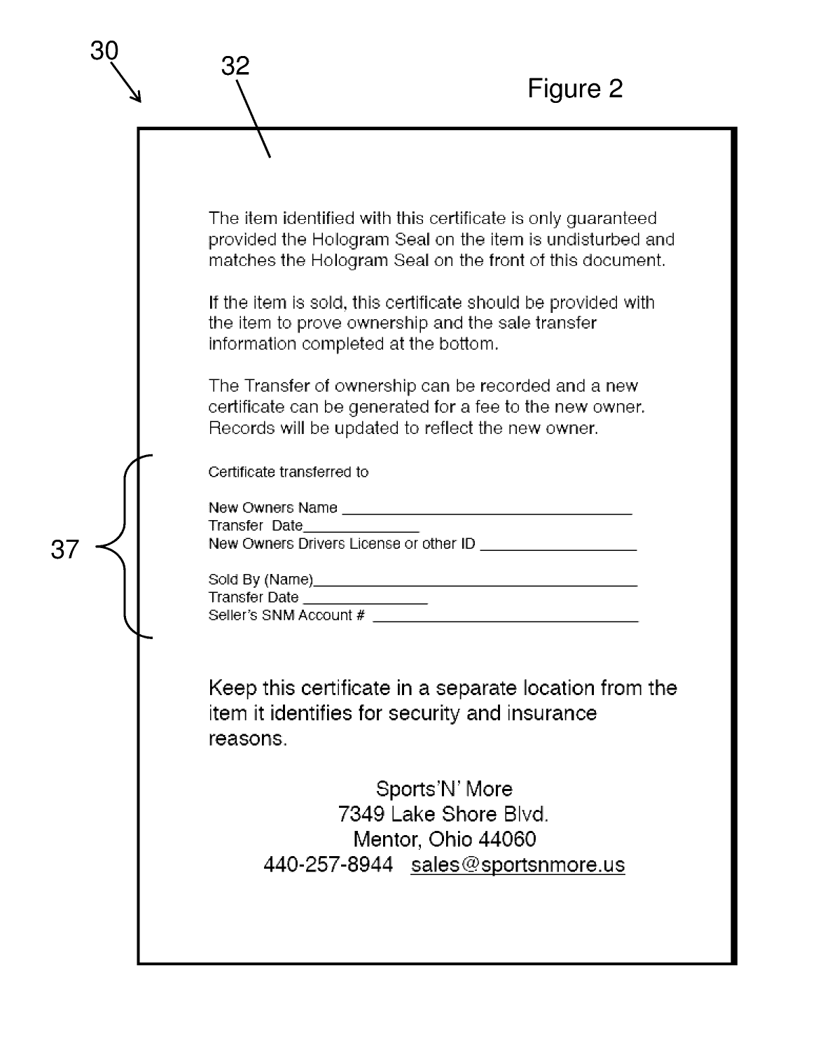

As shown by the certificate template illustrated by FIG. 1, and the completed certificates 30 in FIGS. 1A and 2, the software 24a-24c also implements certificate 30 printing in a predetermined format a predetermined set of item information elements. In the examples shown, this includes elements of descriptive information 38, a grade 16, an identifying photo/image 36 and ownership information. The software 24a-24c also controls entry of data into the registration database 20.

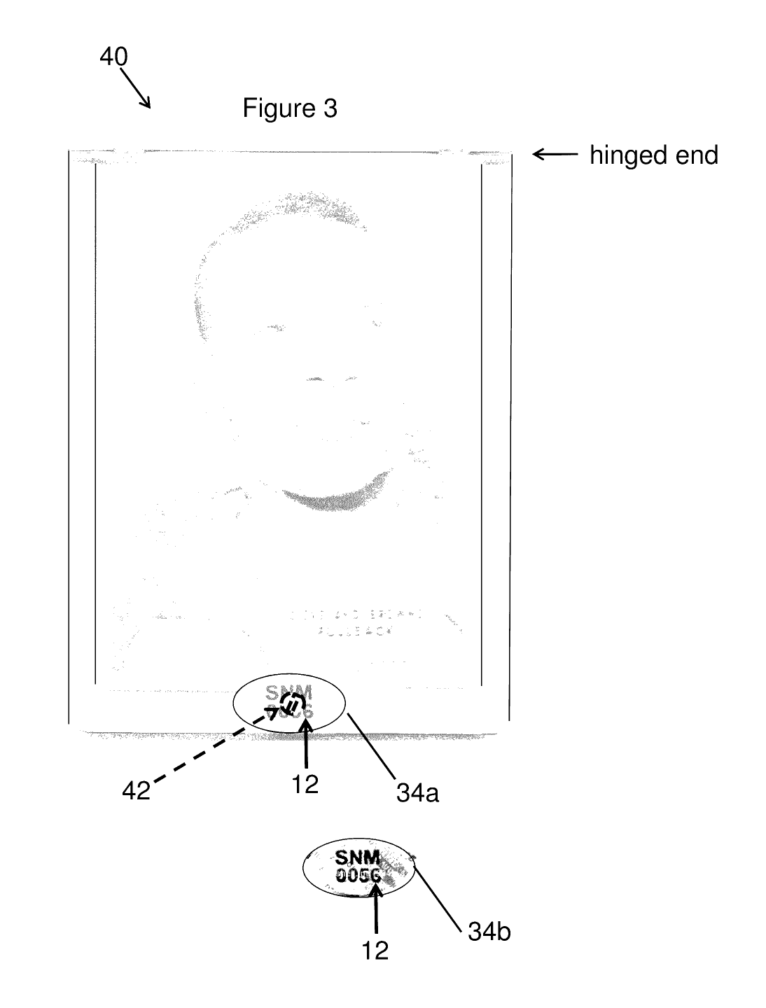

An SNM item identification tag printer 26 is used to generate a label/tag 34 with a unique ID code for each item. This label can be attached to the item as discussed hereinafter. The ID Tag 34 generated by the printer 26 includes the assignment of a unique ID code/number 12 for each item. Referring to FIG. 3, the tag with the unique ID code/number is permanently affixed on the corresponding item or affixed as a tamper-evident ID tag (e.g., 34a) on a secure container 40 containing the item. No more than one duplicate ID tag 34b may also be generated by the identification tag printer 26 and it is permanently affixed to a printed certificate 30 for the item, as seen in FIG. 1A.

The registered item ID code 12 is confirmed by a secure ID tag 34 (seal, label) that displays the ID code, and is permanently and tamper-evidently affixed to the registered item or to a tamper evident enclosure of the item. The tamper evident enclosure forms a adhesive security seal, and if the seal is destroyed, the grade of the item is invalidated. The security seals are formed so that they cannot be duplicated. In the usual case where a physical certificate 30 is produced, there are a maximum of two corresponding ID tags 34a and 34b displaying the same item ID Code 12. One of the tags is permanently and tamper-evidently affixed to the registered item or its container 40, and the second ID tag is permanently and tamper-evidently affixed to the Certificate 30.

The server 18 incorporates SNM owner identification software 28 where each SNM customer who owns one or more items in the SNM database is assigned a permanent, unique Owner ID (account number). The owner ID (account number) is used to identify the customer/owner on the SNM Certificate 30, e.g., on the back side 32 as seen in FIG. 2, and is placed with the item or items to be graded.

As seen in FIGS. 1, 1A, and 2, SNM Certificates 30 for a particular item and owner, may be of two types: e.g., a certificate 30 of SNM grading as seen in FIGS. 1 and 2, and a certificate 30 of item registration, optionally with a grade reported by the owner, as seen in FIGS. 1A and 2.The certificates are generated by the printer 26 from data found in the Registration Database 20 and managed by the server 18. The Registration Certificates 30 act as evidence (physical or virtual) certifying that a particular Owner ID/account is the owner of a particular item having a particular unique ID code, and optionally also having a condition grade as of the date on the certificate. It should be noted that as with stock certificates, a physical (printed) SNM Registration Certificate 30 is optional for use by owners wanting it. All item-specific data that is printed on a Certificate 30 may be included in the Registration Database 20 for access at any time, preferably including an image of the entire front surface of the card, thereby making a “virtual registration certificate.”

The certificate 30 of SNM grading has a front face 31a which displays information items such as those shown in FIG. 1, and is particularly distinguished by reporting an item condition Grade 16 resulting from official evaluation in the SNM system 10 by evaluators 14 utilizing the SNM method 100. If an owner wants to register an item in the SNM registration database 20 without having it evaluated by SNM, then a certificate 30 of registration (only) is issued, having a front face 31b which displays information items such as those shown in FIG. 1A, mainly distinguished by reporting an externally generated item grade 16b, if any is reported by the owner. The accompanying certification statement on the front 31b is appropriately modified versus that on the front 31a of the SNM grading certificate. The back side 32 (FIG. 2) is generally the same as shown for all certificates 30.

The registration certificate 30 is dated when established, and a predetermined set of descriptors are also included to indicate the type of item and other useful identifying information (e.g., for a sports player trading card: player name, card issue year, card number if any). If determined, the SNM condition grade is also displayed for certification. The details of a typical certificate follow.
a. An image (photo or scan) of the item may be printed on the certificate 30, both to further help identification and to also help indicate the item condition. Preferably the certificate card stock surface is off-white color (e.g., pale yellow or ivory) to better show the condition of the item's edges (especially for items like sports cards that have normally white borders).
b. The certificate is printed on a distinctive kind of card/paper stock and has a distinctive size (e.g., 5.5″×7.75″) and print layout (arrangement and format for presenting the specific data about the item, an image of the item, and the ID tag along with standard text on both the front and back of the certificate.
c. The certificate is marked with a trademark (e.g., SNM logo) to confirm that it is the certifying authority.
d. One way to produce a virtual certificate may be to prepare a physical certificate 30 as detailed above, including a second item ID tag that is affixed to it and then scan it to produce virtual certificate (image). After scanning, the physical certificate could be, for example: destroyed, delivered to the owner or an owner-designated certificate holder, securely stored in a location managed by SNM, and the like.

The registration certificate 30 is dated when established, and a predetermined set of descriptors are also included to indicate the type of item and other useful identifying information (e.g., for a sports player trading card: player name, card issue year, card All objects, materials, software, database software and hardware, etc. that are specified for use in the inventive system and method are preferably owned/controlled by, and therefore form a part of the SNM System.

As a result, the objects/materials are made to SNM specifications and can only be obtained through the SNM System (by approved members of the system). Examples include:
a. certificate card stock, preferably preprinted as much as possible;
b. item ID tags (hologram/security seals), preprinted with a non-repeating, un-alterable series of unique ID codes. Optionally a subset of ID codes may be printed on matched pairs of ID tags, and a different subset of ID codes may be printed on single ID tags;
c. tamper-evident item enclosures, made to specifications appropriate for specific types of items to be enclosed. Wherever possible the item enclosures are preferably designed to preserve the condition of the item, or at the very least to not cause any damage.

The registration certificate 30 is dated when established and stored in the database. The certificates 30 are created, maintained, upgraded etc. under the control of the SNM system 10, so all users of the software must obtain it from the System, and use it according to directions of the System.

Item grading/evaluation Specs, methods, and templates for evaluation (worksheets 50) and other database records are likewise created and provided to members by the SNM system 10 (FIG. 10). New Specifications are produced as needed according to requests placed by System Members 14a-14c.

In operation, the method 100 of utilizing the SNM system 10 includes the following steps, as illustrated in FIG. 11. First, in step 102, an individual provides an item to be graded to the System Members 14a-14c. Then, in step 104, the System Members 14a-14c utilize their computers 24, which incorporate the software 24a-24c, to grade the item. The System Members 14a-14c enter the details of the item to be graded into the software, which then generates a score 16a-16c of the item as seen in step 106.

In step 108, the relevant details of the item, including the grading score, are entered into a server 18. In step 110, the server 18 transmits the details of the item into the Registration Database 20, which contains records of data from every issued SNM registration certificate, keyed by owner account number and item ID code.

In step 112, the data within the Registration Database 20 is made available through the server 18 to a secure internet website 22 (e.g., that is cloud based, encrypted, controlled access such as by password, and optionally limited to those with specific permissions).

In step 114, an SNM item identification tag printer 26 is used to generate a label with a unique ID code for each item. This label (ID tag 34) can be attached to the item as discussed hereinafter. The tag generated by the printer 26 includes the assignment of a unique ID code/number for each item. In step 116, the tag with the unique ID code/number is permanently affixed on the corresponding item or affixed as a tamper-evident ID tag on a secure container containing the item.

In step 118, the computer/software 24a-24c generates a permanent, unique Owner ID (account number) for each SNM customer who owns one or more items in the SNM system/database 20.

In step 120, an SNM Certificate 30 (a.k.a. Registration Certificate or Certificate of Grade or ownership) is generated by the printer 26 from data found in the Database 20 and managed by the server 18. The Certificates 30 act as evidence (physical or virtual) certifying that a particular Owner ID/account is the owner of a particular item having a particular unique ID code, and optionally also having an SNM (or identified external) condition grade as of the date on the certificate. In step 122, a physical (printed) SNM Registration Certificate 30 is optionally printed for use by owners wanting it. All item-specific data that is printed on a Registration Certificate 30 may be included in the Registration Database 20 for access at any time.

An example of a typical process for a trading card type of item requiring grading follows.

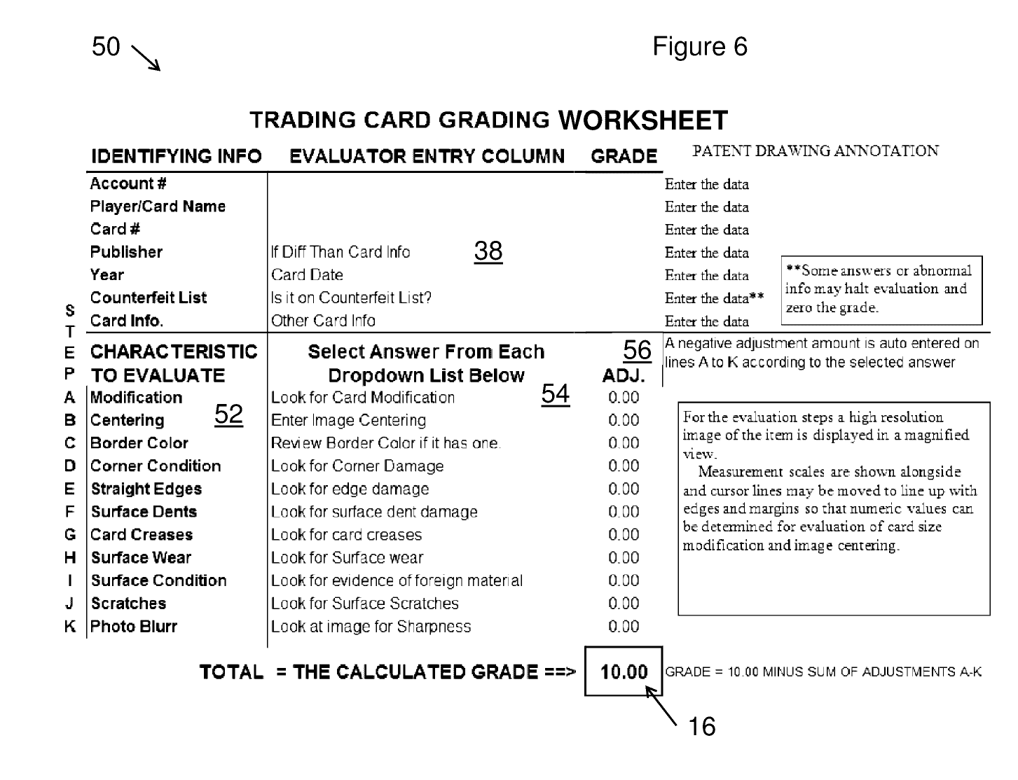

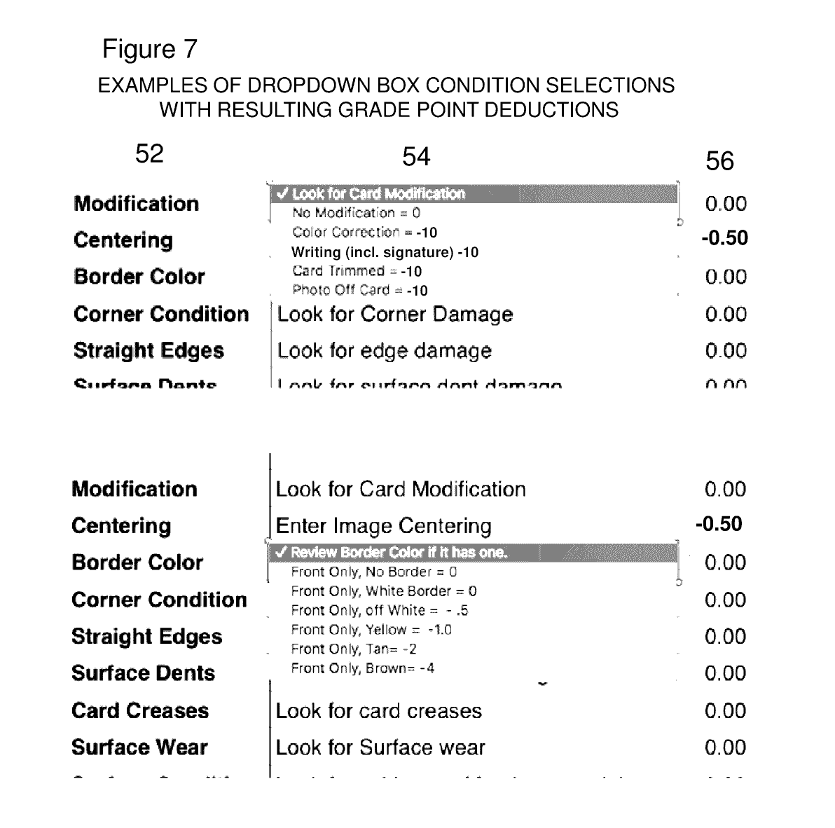

First, the owner of the card brings it to a System Member 14 for evaluation. The System member can initially scan the card into the system with a scanner connected to their computer 24. Then, using the software 24, the member conducts the Trading Card evaluation grading according to criteria embedded in a worksheet 50 as shown in FIGS. 6-7. Each of the criteria can have a dropdown box as shown in FIG. 7 with a predetermined list of specific conditions of each characteristic to determine deduction points 56 used to calculate an overall condition Grade 16. The evaluation results are entered into the worksheet 50 by selecting dropdown list conditions that match the evaluators observations and answers to the criteria.

A evaluation data entry worksheet 50 such as shown in FIG. 6 may be provided that has protected cells with description of characteristics 52 to be evaluated in each step, cells with dropdown lists (FIG. 7) for the grader to select answers that match his/her evaluation of the condition 54 of each characteristic, and corresponding cells that are filled in with a point deduction number 56 given by the selected dropdown list answer. Preferably the point deduction number 56 is automatically entered in response to the selected answer. The adjustment numbers are added up to determine the overall grade 16 (score). Note that the overall grade begins with a perfect score number, such as 10, and is reduced by grade point deductions based on degree of imperfections in the item.

The responsibility of the grader is to establish the condition of the item and not the value. (The value is determined by the market demand of the product by collectors, adjusted according to the condition of the item and the supply of items in a particular condition. For example, demand—and therefore value—will be highest for an item in “mint” condition, and much lower if not zero for lower condition grades.)

The System Member 14 records the customer's account number. For first time users, the customer (owner) is issued a unique account number 37 that will be used for all items owned by the customer, over all time (see FIG. 4). The information can be maintained in the database 20. The account number can appear on the back of a certificate as shown in FIG. 2.

The System Member 14 also enters the details of the item to be graded into the software. Each item being evaluated is given a unique item ID code (or number) 12 which is used to identify the registered/graded item (see FIG. 5). The item ID number will be printed on an ID tag 34.

Records in the Database 20 are maintained by the account number 37 and by the item ID code 12. After the item has been graded, the information including all identifying information and at least the overall grade 16 is stored on hard drives and the cloud for security reasons. In a preferred embodiment, all of the grading evaluation information for an item is stored in the database keyed to the item ID number 12. This may be accomplished by storing a read-only copy 50′ of the specific grading worksheet 50 that was filled out during the item evaluation process. This serves as a permanent record of the worksheet version used, showing all of the characteristics 52 evaluated and all of the characteristic conditions 54 with deduction points 56 that were available for selection, plus of course documenting the selections that were made. Optionally the images used with the evaluation tools are also saved. A later view of this stored worksheet will provide detailed insight into what was evaluated and how the grade was determined with respect to all characteristics of the item condition, thereby explaining the full meaning of the grade that was determined. This is valuable, because evaluation criteria may change over time, particularly for new types of items, and those criteria are documented in the worksheet version used for the evaluation.

The grading result/score/grade 16, and a scan or photo of the item are printed on a SNM Registration Certificate 30, as shown in FIGS. 1-2.

Both the item that is registered/graded and the SNM Registration Certificate have a tamper-evident hologram security ID tag/seal 34 affixed on them. The two seals have the same unique ID code permanently printed or embedded in the hologram pattern in a way that cannot be altered or moved or removed without evident damage/destruction. For example, the unique ID code displayed by the seal/tag may be a SNM serial number, e.g., 4 digits. The hologram seals are prepared in sets of only two seals displaying the same ID code, which is unique because the ID code on a single pair of seals is never used on any other hologram ID tags/seals—i.e., it is a single-use ID code that is only associated with a single item in the database.

The hologram ID tags are “security seals” that use hologram and/or other printing and material technologies to create a permanent unalterable ID display on a label made of an adhesive backed material that will be obviously damaged or destroyed in a tamper-evident way if any attempt is made to remove or move it.

If possible, items are secured in tamperproof (tamper-evident) enclosures 40 that are also protective of the item (to preserve the certified grading). Larger items and items that cannot be suitably enclosed have the hologram ID/security seal 34 affixed directly on the item in a tamper proof/tamper evident way, wherein the tag is irreparably damaged if the container is opened, or the tag removed.

Similarly, the paired hologram ID tag is applied to the certificate card stock in a tamper proof/tamper evident way. Items that are registered for ownership but not graded may optionally not be in a protective enclosure, but still must have the hologram seal affixed in some way that unalterably links the unique ID code to the item.

Enclosure 40 examples include a clamshell hinged plastic case with screw closure (see FIG. 3), sealed by affixing the hologram seal/ID tag 34 to cover the closure screw head 42. Another example, not shown, is a Mylar(R) bag 40 (protective enclosure) with security tape (tamper evident because destroyed if opened). The bag is preferably sized to tightly enclose the item such that no excess material is available to re-seal the bag after cutting it open. Hologram seal/ID tag 34 may be affixed to bag or directly to the item, or to the security tape for an extra level of security.

The Registration certificate 30 can be a special sized (e.g., 5.50″×7.75″) card with a color such as light yellow which better shows edges of the item image printed on it, and is also harder to photocopy or otherwise attempt to duplicate. It is printed on both sides with a standard format: On the front 31a, 31b, a photo/image of the registered item is printed along with the unique hologram ID code displayed on the ID tag which is affixed to the card surface. The certificate date, and summary item identifying info are also printed there. Also the “grade” value is shown if it was determined. If the item is sold or transferred to a new owner, the back 32 of the SNM Owner/registration certificate is printed with blanks to fill in information needed for transfer of ownership of the item (e.g., similar to an auto title). Optionally the owner/account number 37 is printed or filled in (on the “seller's acct no” line) at the time the certificate is issued since the original owner may not be otherwise reported on the certificate 30.

The SNM system will, for a fee, issue a new Registration Certificate 30 referencing the hologram ID number on the original SNM Owner registration certificate. The owner must keep old and new SNM Owner/registration cards 30 together as there are no replacement ID tags.

Loss of the original SNM Owner/registration certificate would require the item to be re-graded when the new Registration Certificate is issued to go with a new hologram ID tag.

The SNM Owner/registration certificate provides security for the owner. If the item is lost due to fire, flood, or theft, the owner has independently certified documentary evidence of owning the item and what it looks like. This information can be shared with insurance companies and law enforcement agencies.

In the case that many or all of the items in a collection are lost, e.g., in a house fire, a report of SNM database records can be generated (for a fee) showing all items that the account number owner had registered and optionally graded in the SNM Registration Certificate program (SNM System).

In the case of selling the item, the purchaser can be assured the item bring sold is not stolen or misplaced property, because the registration certificate describes the item, identifies it using the unique hologram ID, and certifies that the item is owned by the entity having the unique identifying account number. The certificate also confirms the grade or condition of the item if it has been graded.

For remotely located item owners, once an item is graded the SNM Registration Certificate may be mailed to the owner, thereby enabling the owner to establish a current value to be used for shipping insurance. Once the insurance and shipping costs are paid, SNM can ship the item back to the owner. This procedure also assures that the unique certificate is in the possession of the registered owner (account number) before the item with the corresponding ID tag is delivered to the owner. The ownership certification is therefor invalid if the item and the certificate are not both under the control of the same owner (i.e., in a location known to the owner).

Application to Other Collectable Items

The SNM System/Method for collectable item condition indication (e.g., grading) and certification has been disclosed herein mostly as it is applied to the example of trading card collectables, however the disclosed system/method has been developed in a form that should be applicable to almost any kind of collectable item. The herein incorporated provisional application concluded with a long listing of collectable item examples that were presented to show how almost anything that ever existed can be considered worthy of collecting by someone, including both familiar/commonly known items (sports cards, coins . . . ), as well as unusual/uncommon items (eggs, ephemera . . . ). The list is not repeated here, but may be viewed in the provisional application if desired.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method of certifying the condition of a collectible item, the method comprising:
establishing a unique identification number for the item;
evaluating the item and determining a numeric grade for the overall condition of the item;
entering the item identification number and the numeric grade in a worksheet;
saving a read-only record copy of the worksheet in a registration database keyed to the identification number;
generating no more than two identical ID Tag labels with the identification number for the item;
creating a separate registration certificate that displays the numeric grade for the overall condition and other identifying information for the item;
applying one of the identical labels to the registration certificate; and
applying the other one of the identical labels to the item or to a container of the item.

2. The method of claim 1 including:
packaging the item in a container; and
making the container tamper-evident by sealing the container with one of the two ID Tag labels, wherein the ID Tag is irreparably damaged if the container is opened.

3. The method of claim 1 including determining the numeric grade according to a predetermined set of grading criteria and selectable conditions for each characteristic of the type of item being graded.

4. The method of claim 3 including selecting grade-determining characteristic conditions from a list of item-specific characteristics wherein each characteristic has an associated list of condition descriptors and corresponding grade point deductions.

5. The method of claim 3 wherein evaluating the item is computer assisted and the worksheet of computer data entry software has the predetermined grading criteria with characteristics and selectable conditions embedded in it.

6. The method of claim 5 including:
evaluating each item characteristic in a predetermined list;
selecting a corresponding condition descriptor from the list of descriptors provided for the characteristic;
entering the corresponding grade point deduction that is shown with the selected descriptor; and
calculating the item grade being a perfect score number minus a sum of the grade point deductions.

7. The method of claim 1 including forming the identical labels as adhesive security seals displaying the unique identification number.

8. The method of claim 7 including forming the security seals so that they cannot be duplicated.

9. The method of claim 6 including simultaneously displaying an image of the item along with an evaluation tool to aid in evaluating the condition of an item characteristic.

10. The method of claim 9 including measuring the item image with on-screen measurement tools.

11. The method of claim 9 including looking for, and evaluating image defects with image enhancement tools.

12. The method of claim 7 including invalidating the grade when the adhesive security seal is destroyed.

13. The method of claim 1 further including making the data within the registration database available to a secure internet website.

14. The method of claim 13 further including restricting access to the internet website utilizing cloud based, encrypted, controlled access.

15. The method of claim 1 further including generating a permanent, unique Owner Identification number for an owner of the item.

16. The method of claim 1 further including printing a registration certificate.

17. A method of certifying the condition of a collectible item, the method comprising:
establishing a unique identification number for the item;
evaluating the item by utilizing a grading system member's computer which incorporates software of the system;
entering descriptive details of the item into the software;
generating a grade of the item's condition;
entering the grade into a server; and
generating an ID label with the unique ID number for the item.

18. The method of claim 17 including transmitting details of the item into a Registration Database, containing records of data from all items entered.

19. The method of claim 18 further including permanently affixing the ID label on the corresponding item.

20. The method of claim 17 further including generating a permanent, unique identification number for an owner of the item.
